(19) United States
(12) Patent Application Publication
(10) Pub. No.: US 2023/0133944 A1
(43) Pub. Date: May 4, 2023

(54) MESSAGE PROCESSING METHOD, APPARATUS, AND DEVICE, STORAGE MEDIUM AND SYSTEM

(71) Applicant: ZTE CORPORATION, Guangdong (CN)

(72) Inventors: Zheng ZHANG, Guangdong (CN); Benchong XU, Guangdong (CN)

(73) Assignee: ZTE CORPORATION, Guangdong (CN)

(21) Appl. No.: 17/913,324

(22) PCT Filed: Dec. 8, 2020
(86) PCT No.: PCT/CN2020/134537

§ 371 Date: Sep. 21, 2022

(30) Foreign Application Priority Data
Mar. 26, 2020 (CN) 202010223721.4

(51) Int. Cl. H04L 45/16; H04L 45/00; H04L 45/02

(52) U.S. Cl. CPC H04L 45/16; H04L 45/14; H04L 45/04

(57) ABSTRACT

Provided are a message processing method and apparatus, a device, a storage medium, and a system. The message processing method includes: multiple source group query messages respectively sent by multiple second communication nodes are received; a report message is determined based on the multiple source group query messages and a second communication node of the multiple second communication nodes is selected based on the multiple source group query messages; and the report message is sent to the selected second communication node.

### CROSS-REFERENCE TO RELATED APPLICATIONS

This is a National Stage Application filed under 35 U.S.C. 371 based on International Patent Application No. PCT/CN2020/134537, filed on Dec. 8, 2020, which claims priority to Chinese Patent Application No. 201110223721.4 filed on Mar. 26, 2020, the disclosures of both of which are incorporated herein by reference in their entireties.

### TECHNICAL FIELD

The present application relates to the field of wireless communication networks, and for example, a message processing method and apparatus, a device, a storage medium, and a system.

### BACKGROUND

When the multicast listener discover (MLD) is used as a bit indexed explicit replication (BIER) overlay layer technology, the implementation scheme may cause multiple edge nodes to receive unwanted report information. Moreover, in a scenario that multiple BIER domain ingress devices forward a same multicast traffic, or when a same group of multi-source scenarios occur, a situation that repeated multicast traffic transmissions exist in a BIER domain may occur, and thus the network bandwidth waste is caused.

### SUMMARY

The present application provides a message processing method and apparatus, a device, a storage medium, and a system.

An embodiment of the present application provides a message processing method. The method is applied to a first communication node and includes the following. Multiple source group query messages respectively sent by multiple second communication nodes are received; a report message is determined based on the multiple source group query messages and any second communication node of the multiple second communication nodes is selected based on the multiple source group query messages; and the report message is sent to the selected second communication node.

An embodiment of the present application provides a message processing method. The method is applied to a second communication node and includes the following. A source group query message is sent to a first communication node, where the source group query message is used by the first communication node to determine any second communication node and a report message; and multicast traffic is processed based on the received report message.

An embodiment of the present application provides a message processing apparatus. The apparatus is configured at a first communication node and includes a first receiving module, a determination module and a first sending module. The first receiving module is configured to receive multiple source group query messages respectively sent by multiple second communication nodes. The determination module is configured to determine a report message and any second communication node based on the multiple source group query messages. The first sending module is configured to send the report message to the selected second communication node.

An embodiment of the present application provides a message processing apparatus. The message processing apparatus is configured at a second communication node and includes a second sending module and a processing module. The second sending module is configured to send a source group query message to a first communication node, where the source group query message is used by the first communication node to select any second communication node and send a report message. The processing module is configured to process multicast traffic based on the received report message.

An embodiment of the present application provides a device. The device includes one or more processors and a memory. The memory is configured to store one or more programs. The one or more programs, when executed by the one or more processors, cause the one or more processors to implement any of the methods in the embodiments of the present application.

An embodiment of the present application provides a non-transitory computer-readable storage medium. The storage medium stores a computer program. The computer program, when executed by a processor, implements any of the methods in the embodiments of the present application.

An embodiment of the present application provides a message processing system. The system includes a first communication node and a second communication node. The second communication node is configured to send a source group query message to a first communication node. The first communication node is configured to: receive multiple source group query messages respectively sent by multiple second communication nodes, determine a report message and any second communication node based on the multiple source group query messages, and send the report message to the selected second communication node. The second communication node is configured to process multicast traffic based on the received report message.

### BRIEF DESCRIPTION OF DRAWINGS

FIG. 1 is a schematic structural diagram of one multicast source connecting two BFIRs;

FIG. 2 is a schematic structural diagram of a same multicast group corresponding to multiple multicast sources;

FIG. 3 is a flowchart of a message processing method provided in the present application;

FIG. 4 is a flowchart of a message processing method provided in the present application;

FIG. 5 is a schematic diagram of a processing method of an ingress BFIR device provided in the present application;

FIG. 6 is a schematic diagram of a processing method of an egress BFIR device provided in the present application;

FIG. 7 is a schematic structural diagram of a BFIR device and a BFIR device provided in the present application;

FIG. 8 is a schematic structural diagram carried in a form of a type-length-value (TLV) provided in the present application;

FIG. 9 is a schematic structural diagram of a message processing apparatus provided in the present application;

FIG. 10 is a schematic structural diagram of a message processing apparatus provided in the present application; and

FIG. 11 is a schematic structural diagram of a device provided in an embodiment of the present application.

### DETAILED DESCRIPTION

Embodiments of the present application will hereinafter be described with reference to the accompanying drawings.

The processes shown in the flowcharts of the accompanying drawings may be executed in a computer system, such as a set of computer-executable instructions. Moreover, while a logical order is shown in the flowcharts, in some cases, processes shown or described may be performed in a different order than herein.

The multicast technology is gaining increasing applications on the Internet, such as multi-party conferencing, remote education, telemedicine, live webcasting. More and more applications also continuously promote the development and perfection of the multicast technology.

A bit indexed explicit replication (BIER) is a novel multicast data forwarding technique. According to the technology, nodes at a edge of a network are represented by only one bit, multicast traffic is transmitted in an intermediate network, a specific BIER packet header is additionally packaged, all destination nodes of the multicast traffic are marked by the above-described BIER message header in a bit string form, and an intermediate network forwarding node routes according to the bit, so that the multicast traffic can be ensured to be sent to all destination nodes.

The intermediate network forwarding node floods and sends node information through an internal protocol beforehand so as to form a bit index forwarding table (BIFT) for guiding a BIER forwarding, the internal protocol is such as an open shortest path first (OSPF) protocol, an intermediate system-to-intermediate system (ISIS) protocol, a border gateway protocol (BGP) or a Babel protocol in a three-layer network. When the intermediate network forwarding node receives the multicast traffic of the encapsulated BIER header, a forwarding of the packet to the destination node is completed according to the BIFT. The BIER data plane forwarding technology eliminates the time delay of a multicast tree establishment because of no multicast tree establishment problem, the convergence speed of the BIER data plane forwarding technology is the same as that of the OSPF protocol and the ISIS protocol, which greatly reduced the time delay compared with the original multicast tree reestablishment.

Although the BIER technology is used for transmission, only one piece of multicast traffic needs to be encapsulated in a BIER packet to be transmitted as a payload. But for a bit-forwarding ingress router (BFIR) of a BIER domain, it is necessary to know which bit-forwarding egress routers (BFERs) of the BIER domain need this piece of multicast traffic, so that after the BFER receives this piece of multicast traffic, the multicast traffic may be forwarded to a multicast receiver outside the BIER domain that needs to receive this piece of traffic.

Between the BFIR and the BFER, a static configuration mode is adopted, and a dynamic announcement protocol may also be adopted to enable the BFIR to know the BFERs corresponding to one piece of multicast traffic. This is referred to as the BIER overlay technique. The draft-ietf-bier-mld-03 draft of the internet engineering task force (IETF) propose the use of the multicast listener discovery (MILD) protocol/internet group management protocol (IGMP) as the BIER overlay technology. According to the technology, the BFIR can learn the BFERs corresponding to the multicast traffic through an MLD protocol. The method may work normally under a simple network. The MLD overlay solution, although simple per se, suffers from drawbacks for a large network or a slightly complex deployment scenario. The MLD hereinafter in this application refers broadly to MLD and IGMP.

In a slightly complex networking scenario, the MLD overlay solution is problematic.

Firstly, multiple devices at the edge of, such as the BIER domain, may be used as BFIR and BFER devices. Therefore, multiple BFIRs are used as queriers. When the BFER sends a report packet to “all BMLD Queriers” according to the draft-ietf-bier-mld-03 draft mechanism, all BFIRs receive the same report packet, even if flows of the report do not have a relationship with the BFIR at all. This may result in a useless processing consumption of the device.

Secondly, in order to ensure the sending of the multicast traffic, a situation that one multicast source is connected to two or more BFIRs will typically be deployed, two BFIRs are used as an example, the two BFIRs send a universal query packet, and the BFER needing to receive the packet also responds a report packet to the two BFIRs, so that two BFIRs send traffic to the BFER, which may cause the BFER to receive duplicate traffic.

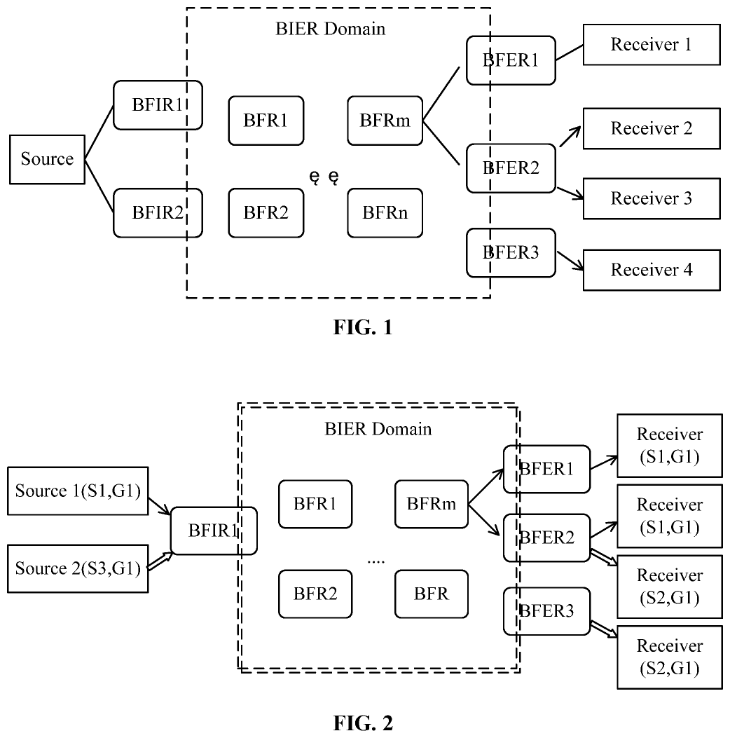

FIG. 1 is a schematic structural diagram of one multicast source connecting two BFIRs, as shown in FIG. 1, one multicast source is simultaneously connected to two devices, i.e., a BFIR1 and a BFIR2, so as to avoid a single point of failure, and a BFER1, a BFER2 and a BFER3 all have the multicast traffic needed by receivers. When the draft-ietf-bier-mld-03 draft mechanism is used, the BFIR1 and the BFIR2 receive a report message from the BFER1, the BFER2 and the BFER3, such that the BFIR1 and the BFIR2 may consider that the multicast traffic needs to be forwarded to the BFER1, the BFER2 and the BFER3. Therefore, the intermediate node actually needs to process double traffic, the network bandwidth is occupied, and the processing resources of the intermediate node are also occupied. The BFER1, the BFER2 and the BFER3 will thus also receive duplicate traffic, and the BFER needs to specifically identify the source of the traffic and select one to discard.

In addition, in some deployment scenarios, for a same multicast group, there may be multiple multicast sources corresponding to the same multicast group, and such multiple pieces of multicast traffic may also need to be transmitted in the network, but some receivers may only want to receive flows from one source, and the BFER may also receive unwanted flows, which causes a significant waste of network resources.

FIG. 2 is a schematic structural diagram of a same multicast group corresponding to multiple multicast sources, as shown in FIG. 2, the BFIR1, in conjunction with two sources S1 and S2, corresponds to a same group G1, the BFER1, the BFER2 and the BFER3 have different reception requirements, the BFER1 only wants to receive flows from (S1, G1), and the BFER3 only wants to receive flows from (S2, G1). After the BFIR sends a querier packet to the BFERs, the report packet sent by the BFERs enables the BFIR to send both flows to the BFER1, the BFER2 and the BFER3, so that the BFER1 and the BFER3 receive unwanted flows, and waste of resources such as network bandwidth is caused.

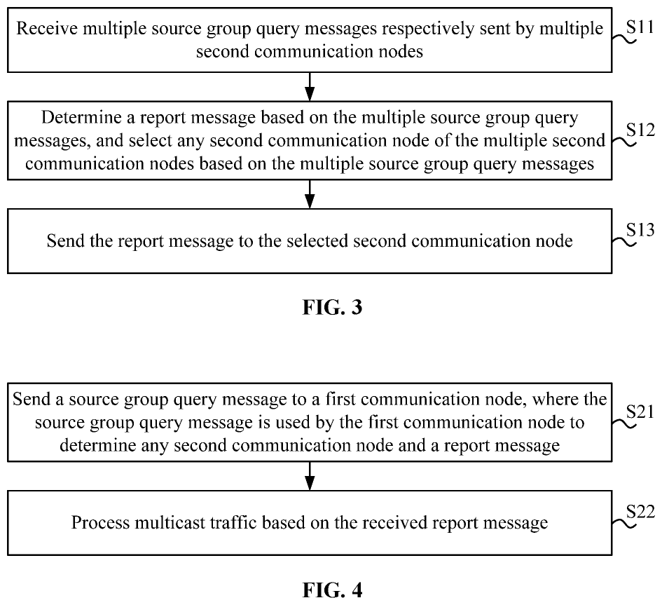

This embodiment provides a message processing method. FIG. 3 is a flowchart of a message processing method provided in the present application. This method may be suitable for a condition of multicast information interaction in a large network or a slightly complex deployment scenario. The method is applied to a first communication node, the method may be performed by a message processing apparatus provided in the present application, and the message processing apparatus may be implemented by software and/or hardware.

As shown in FIG. 3, the message processing method provided in the embodiment of the present application mainly includes processes S11, S12 and S13.

In S11, multiple source group query messages respectively sent by multiple second communication nodes are received.

In S12, a report message is determined based on the multiple source group query messages and any second communication node of the multiple second communication nodes is selected based on the multiple source group query messages.

In S13, the report message is sent to the selected second communication node.

In this embodiment, the first communication node may be understood as an egress BFER device of an edge node in the BIER domain, and the second communication node may be understood as an ingress BFIR device of an edge node in the BIER domain. The first communication node and the second communication node in this embodiment are described for distinction only and are not intended to be limiting.

In this embodiment, the source group query message carries group information and source information, the group information may be understood as a destination address to be reached by the multicast traffic, and the source information may be understood as a source address of the multicast traffic. Only the group information and the source information are exemplarily described in this embodiment, and the group information and the source information may be other information and are not limited in this embodiment.

In an exemplarily implementation, that any second communication node of the multiple second communication nodes is selected based on the multiple source group query messages includes: in a case where a same multicast traffic corresponds to the multiple second communication nodes, one second communication node is selected from the multiple second communication nodes based on a preset selection algorithm.

In this embodiment, the same multicast traffic may be understood as both the group information and the source information being the same. The same multicast traffic may be multicast traffic that both the source address and the destination address are the same.

The same multicast traffic corresponding to the multiple second communication nodes may be understood that the same multicast traffic may be sent to the first communication node through the multiple second communication nodes.

In a case where the same multicast traffic corresponds to the multiple second communication nodes, the one second communication node being selected from the multiple second communication nodes based on the preset selection algorithm may be understood as that the first communication node receives the source group query messages sent by the multiple second communication nodes; and the source group query messages sent by the multiple second communication nodes are the same, and the first communication node may select the one second communication node from the multiple second communication nodes based on the preset selection algorithm and send the report message to the selected second communication node.

In an exemplarily implementation, the preset selection algorithm includes one or more of: a selection of a second communication node with a lowest bit-forwarding router-prefix (BFR-Prefix) value, a selection of a second communication node with a highest BFR-Prefix value, a selection of a second communication node with a lowest BFR-ID value, a selection of a second communication node with a highest BFR-identifier (ID) value, or a highest random weight (HRW) algorithm.

In practical application, any one of the above-described selection algorithms may be selected to select the second communication node.

In an exemplarily implementation, that the one second communication node is selected from the multiple second communication nodes based on the HRW algorithm includes: a weight value of each second communication node of the multiple second communication nodes is determined; and a second communication node corresponding to a maximum weight value among multiple determined weight values is determined as the selected second communication node.

In this embodiment, the weight value of the second communication node is determined by the following formula:

Wrand(S,G,Ai)=(1103515245*((1103515245*Ai+12345)XOR D(S,G))+12345)(mod 2\hat{ }31).

For the Internet Protocol version 4 (IPv4) scenario, D(S, G) may be a 31-digit digest value after the source group information of the multicast flow is subjected to an AND operation and the highest digit is removed. A is then a 32-bit BFR-Prefix address of the BFIR. BFR-Prefixs of different BFIRs correspond to different Ai values.

For an IPv6 scenario, D(S, G) may be a 31-bit digest value after the source group information of the multicast flow is subjected to a HASH operation. A is then a 32-bit value obtained after the HASH is performed on a 128-bit BFR-Prefix address of the BFIR. BFR-Prefixs of different BFIRs correspond to different Ai values.

After a weight Wrand value is calculated for all alternative BFIRs, a BFIR corresponding to the maximum weight value is selected as the selected BFIR.

In an exemplary implementation, the weight value of the second communication node is determined by the group information and the source information carried in a source group query message corresponding to this second communication node.

In an exemplary implementation, the report message is determined based on the multiple source group query messages includes: flow information in the multiple source group query messages is compared with flow information needed to be received locally; and flow information which does not need to be received locally in the flow information in the multiple source group query messages is written into filtering information; where the filtering information is carried in the report message.

In this embodiment, the first communication node stores the source group information in the source group query packet, the source group information is compared with the source group information that needs to be received locally, and then an EXCLUDE filtering mode is used to carry the source information that does not need to be received when the report information is sent, so that unnecessary traffic being received is avoided.

In an exemplary implementation, the filtering information is carried in a form of a type-length-value (TLV).

In an exemplary implementation, this embodiment provides a message processing method. FIG. 4 is a flowchart of a message processing method provided in the present application. This method may be suitable for a condition of multicast information interaction in a large network or a slightly complex deployment scenario. The method is applied to a second communication node, the method may be performed by a message processing apparatus provided in the present application, and the message processing apparatus may be implemented by software and/or hardware.

As shown in FIG. 4, the message processing method provided in the embodiment of the present application mainly includes processes S21 and S22.

In S21, a source group query message is sent to a first communication node, where the source group query message is used by the first communication node to determine any second communication node and a report message.

In S22, multicast traffic is processed based on the received report message.

In this embodiment, the method in which the first communication node determines the any second communication node and the report message may refer to the description in the above-described embodiments, which is not limited again in this embodiment.

In an exemplary implementation, the source group query message carries group information and source information, and the group information and the source information are used for the first communications node to determine a weight value of the second communication node.

In this embodiment, the method in which the weight value is determined based on the group information and the source information may refer to the description in the above-described embodiments, which is not limited again in this embodiment.

In an exemplary implementation, that the multicast traffic is processed based on the received report message includes: the multicast traffic is sent to the first communication node corresponding to the report information.

The second communication node receiving the report message indicates that the first communication node selects the second communication node to send the multicast traffic, and the second communication node sends the multicast traffic to a corresponding first communication node.

In an exemplary implementation, that the multicast traffic is sent to the first communication node corresponding to the report information includes: in a case where filtering information is carried in the report message, the multicast traffic corresponding to the filtering information is filtered; and the filtered multicast traffic is sent to the first communication node corresponding to the report information.

In this embodiment, the filtering information carries source information of multicast traffic unwanted for the first communication node, the multicast traffic unwanted for the first communication node is filtered, and only the filtered multicast traffic, that is, the multicast traffic needed by the first communication node is sent to the first communication node.

In an exemplary implementation, that the multicast traffic is processed based on the received report message includes: a correspondence between the multicast traffic and the first communication node is determined based on the report information; and the correspondence is encapsulated in a bit indexed explicit replication (BIER) header.

In an application embodiment, the present application proposes an optimization scheme that the MLD protocol serves as the BIER overlay protocol, and it is adapted to randomly deployed networks, and a situation that redundant traffic is transmitted in the network does not occur.

Firstly, the BFIR is configured to send a specified source group query message instead of a general query message, where the source group query message carries not only the group information but also corresponding source information.

Secondly, the BFER selects only one BFIR to send the report message in a case where multiple sources in a same group are found or multiple BFIRs in the same flow are found.

The selection algorithm may be judged simply according to the BFR-Prefix or the BFR-ID value of the BFIR, and also may be judged according to a certain algorithm, such as an HRW algorithm.

Thirdly, when the BFER sends a report packet, a filtering mode carrying an EXCLEDE is selected, and an source address which is not expected to be received is written in an EXCLEDE list, so that unnecessary traffic being received is avoided.

The EXCLUDE filtering mode may be carried in a simplified form of TLV.

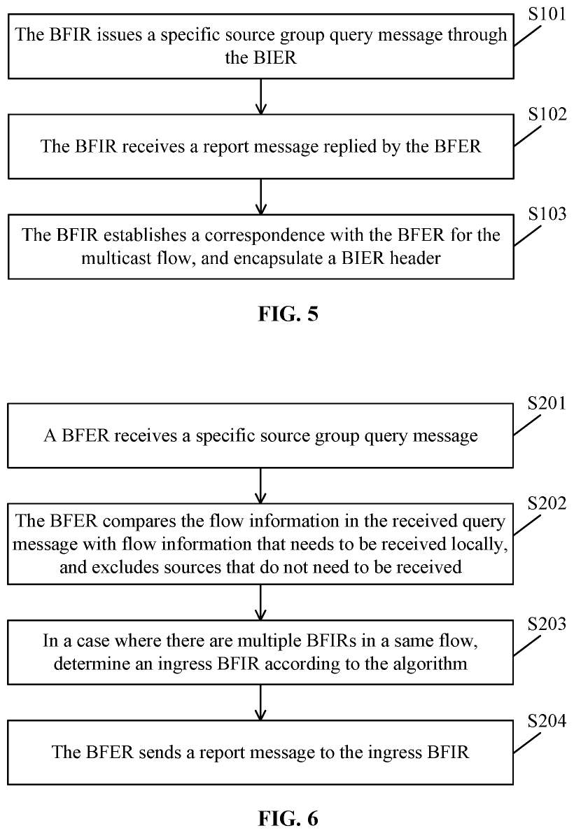

FIG. 5 is a schematic diagram of a processing method of an ingress BFIR device provided in the present application, and as shown in FIG. 5, a processing flow of the ingress BFIR device mainly includes the following.

In S101, the ingress BFIR device sends a specific source group query message to a BFER device for each multicast flow.

In S102, after a report message replied by a BFER is received, the ingress BFIR device processes the report message, and if the report message carries an EXCLUDE mode, then the ingress BFIR device does not send a flow to a corresponding BFER.

In S103, the ingress BFIR device determines a BFER correspondence between the flow and a receiver and sends the BFER correspondence to a forwarding layer, so that multicast traffic is encapsulated according to the correspondence when a BIER header is encapsulated, and the multicast traffic is prevented from being sent to the receiver which is not needed.

FIG. 6 is a schematic diagram of a processing method of an egress BFER device provided in the present application, and as shown in FIG. 6, a processing flow of the egress BFER device mainly includes the following.

In S201, a BFER receives a specific source group query message from an ingress BFIR device, and records a BFIR and corresponding flow information.

In S202, the BFER compares the flow information in the received query message with flow information that needs to be received and is known locally from a receiver, and determines which flows are needed by the local receiver. When different sources in a same group exist, an EXCLUDE filtering mode is generated to eliminate flows corresponding to unwanted sources.

In S203, in a case where there are multiple ingress BFIRs in a same flow, the BFER needs to run a selection algorithm to select BFIRs that needs to respond, and the algorithm may be a relatively simple algorithm, or may be an HRW algorithm and the like.

In S204, the BFER responds a report message to the selected BFIR, and if there is the EXCLUDE filtering mode, the report message needs to carry traffic information corresponding to an excluded source.

In a BIER domain, some devices are connected to both a multicast source and the receiver, and such devices are both the BFIR and the BFER device.

In an application embodiment, in a case where same multicast traffic is connected to multiple BFIRs, or there are multiple sources in a same group, the BFIR is configured to send a specific source group query message instead of a general query message, and both a multicast group and source information are carried in the query message and sent to the BFER. The BFER responds to the report message based on local receiver conditions.

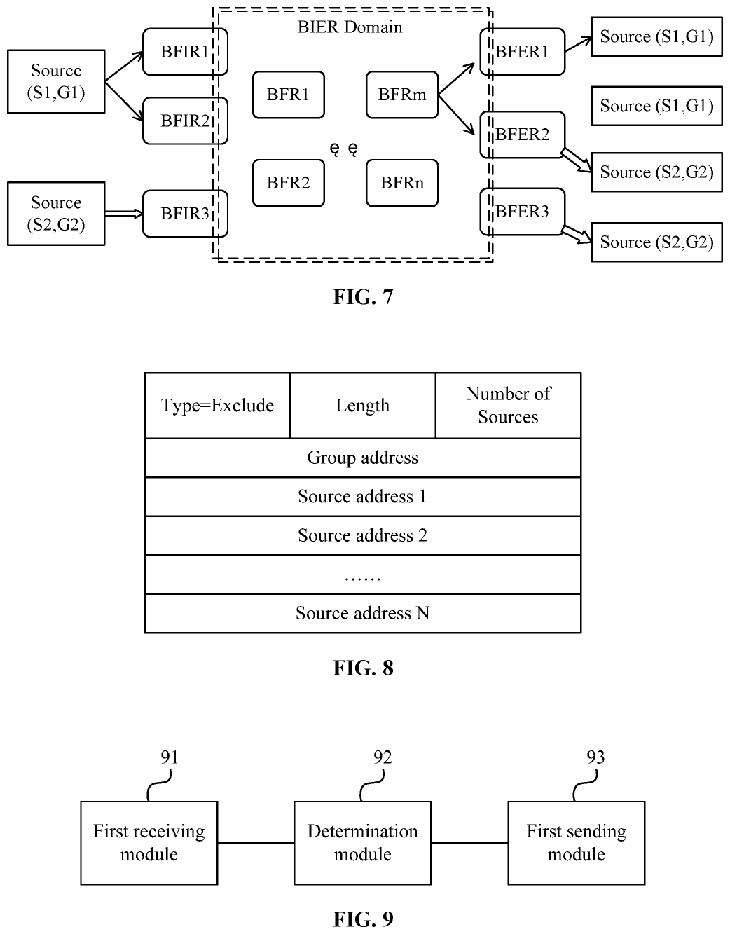

FIG. 7 is a schematic structural diagram of a BFIR device and a BFER device provided in the present application. In the example shown in FIG. 7, a BFIR1 and a BFIR2 will advertise a specific source group query message of (S1, G1), and a BFIR3 will advertise a specific source group query message of (S2, G2). The advertisement mode may be in a format similar to that of a specific source group query message specified in request for comment 3376 (RFC 3376). A BFER1, a BFER2 and a BFER3 will receive these query messages. Assuming that the BFER1 and the BFER2 both select the BFIR1 as an ingress device for the (S1, G1), the BFER1 and the BFER2 will send a report message containing the (S1, G1) to the BFIR1, and the BFER2 and the BFER3 will send a report message containing the (S2, G2) to BFIR3.

The report message may also be formatted as a specific source group report message as defined in the RFC 3376. Therefore, the BFIR1 sends traffic of the (S1, G1) to the BFER1 and the BFER2 through other devices in a BIER domain. The BFIR3 sends traffic of the (S2, G2) to the BFER2 and the BFER3 through other devices in the BIER domain. Because the report message sent by the BFER is not sent to the “all BMLD Queriers” device, that is, a BFER1 device, a BFER2 device, a BFER3 device, the BFIR2 will not receive the report message sent by the BFER, nor will the BFIR2 pushes the traffic to the BFER1/BFER2. This prevents the BFER1 and the BFER2 from receiving duplicate traffic.

When the report message is sent, only a BFR-id value of the selected BFIR is filled in the Bitstring in the encapsulated BFIR packet. A MILD message is encapsulated in a BIER packet as a payload, and the “all BMLD Queriers” address originally defined may still be used as an IP packet address of the encapsulation MHLD, but the address will not affect the delivery of the BIER packet.

In an application embodiment, for the same flow, care should be taken to select the same BFIR as much as possible in a case where multiple BFERs are to receive the flow. For example, in FG. 1, the BFER1, the BFER2, and the BFER3 all need to receive the same flow, and the BFIR1 may be selected as the ingress device, or the BFIR2 may be selected as the ingress device, and handling of the ingress device is simplified as much as possible.

Upon selecting the BFIR, a simple algorithm may be adopted, for example, only the BFIR with the lowest or highest BFR-Prefix, or with the lowest or highest BFR-ID among the candidate BFIRs may be used as the ingress device, or a specific algorithm may be adopted to select the BFIR, so as to avoid that when a new BFIR connected to the same source is added, the selection result will be affected, and a switching to a new BFIR device is caused. A particular algorithm may be a HRW algorithm or other hash algorithm. The HRW algorithm is used as an example here:

Wrand(S,G,Ai)=(1103515245*((1103515245*Ai+12345)XOR D(S,G))+12345)(mod 2\hat{ }31).

For an IPv4 scenario, D (S, G) may be a 31-digit digest value after the source group information of the multicast flow is subjected to an AND operation and the highest digit is removed. A is then a 32-bit BFR-Prefix address of the BFIR. BFR-Prefixs of different BFIRs correspond to different Ai values.

For an IPv6 scenario, D (S, G) may be a 31-bit digest value after the source group information of the multicast flow is subjected to a HASH operation. A is then a 32-bit value obtained after the HASH is performed on a 128-bit BFR-Prefix address of the BFIR. BFR-Prefixs of different BFIRs correspond to different Ai values.

After a weight Wrand value is calculated for all candidate BFIRs, a BFIR corresponding to the maximum weight value is selected as the selected BFIR.

For example, in FIG. 1, both the BFIR1 and the BFIR2 are connected to the same source. Assuming that the traffic sent by this source is the (S1, G1), the MLD Query message sent by the BFIR1 and the BFIR2 will carry this flow information, the BFER1, the BFER2 and the BFER3 need to make a selection, and the BFER1, the BFER2 and the BFER3 may all select the BFIR1 as the BFIR because it has a higher BFR-Prefix/BFR-ID. Assuming that there is another BFIR3 that is connected to the same source and has a higher BFR-Prefix/BFR-ID than the BFIR1 and the BFIR2, the BFER will reselect to the BFIR3. This will cause the network handover turbulence, may cause the traffic loss. Using the HRW algorithm for calculation will make the result not easy to change. Even if a new device is added, unnecessary traffic switching is not caused. Therefore, in the same example, the BFER selects the BFIR1 as the ingress device to send the report message through the HRW calculation, and does not switch to the BFIR3 even if the BFIR3 is added subsequently.

In an application embodiment, in some cases, even if only one BFIR device is selected to send the report information, a problem is still caused. As shown in FIG. 2, the multicast sources, i.e., a Source1 and a Souce2, are both connected to the BFIR1 device, and the two sources are for the same multicast group G1 to send traffic, but the sources S are not the same. Assuming that the BFER1 only wants to receive traffic of the (S1, G1), the BFER3 only wants to receive traffic of the (S2, G1), and the BFER2 all want to receive. However, when the BFIR sends the query message, even if a specific source group query packet is used, report packets responded by the BFER1, the BFER2, and the BFER3 cannot allow the BFIR to distinguish different traffics received by the BFERs, which will cause the BFER1 and BFER3 to receive additional traffic, and thus network resources will also be wasted.

Therefore, after the BFIR sends the specific source group query packet, the BFER needs to save all source group information in the query packet, and then the all source group information is compared with the source group information needed by the local receiver, and then, when a response report packet is sent, the EXCLUDE filtering mode is used to carry source information that does not need to be received, so that unnecessary traffic being received is avoided.

Likewise, FIG. 2 is used as an example, the BFIR1 encapsulates the information of the (S1, G1) and the (S2, G1) in the specific source group query packet and sends it. After the BFER1, the BFER2 and the BFER3 receive it, the BFER1, the BFER2 and the BFER3 will compare it with the traffic required locally. The BFER1 and the BFER3 will find that local does not need to receive traffic from both the S1 and the S2, but only one of the S1 and the S2. The BFER1 and the BFER3 will actively trigger the carrying of the EXCLUDE filtering mode in the report packet. The BFER1 will use the EXCLUDE filtering mode to indicate that no traffic is required, and the BFER3 will use the EXCLUDE filtering mode to indicate that no traffic is required. Because traffic from both sources is required, the BFER2 does not need to carry the EXCLUDE mode to send in the report message. The EXCLUDE content may be carried in a filter mode similar to that defined in the RFC3376, or may be carried simply in a form of a TLV as shown in FIG. 8, FIG. 8 is a schematic structural diagram carried in a form of a TLV provided in the present application, the form of TLV shown in FIG. 8 is used for carrying, so that the protocol processing flow may be simplified on the BFER device. As shown in FIG. 8, the form of TLV includes a type, a length, and a number of sources.

In this way, after the report packet is received, the BFIR1 may clearly know that the BFER corresponding to the (S1, G1) is the BFER1 and the BFER2, and the BFER corresponding to the (S2, G1) is the BFER2 and the BFER3. In this way, there is no additional traffic transmission in the network, and BFER does not receive unnecessary traffic.

With different deployment modes, the method in the above-described embodiments may be used independently or in combination, so as to avoid transmission of redundant and repeated traffic, improve utilization efficiency of network resources, and promote the wide application of multicast, especially the BIER technology.

BIER technology is widely used in the network, the MILD will play an important role as the simplest overlay protocol. For a slightly complex network, the present application may play a role of saving a network bandwidth, reducing extra overhead of network node processing, and promoting the development of the network multicast technology.

In an exemplary implementation, this embodiment provides a message processing apparatus, FIG. 9 is a schematic structural diagram of a message processing apparatus provided in the present application. The apparatus may be suitable for a condition of multicast information interaction in a large network or a slightly complex deployment scenario. The apparatus is configured at a first communication node, and the message processing apparatus may be implemented by software and/or hardware.

As shown in FIG. 9, the message processing apparatus provided in the embodiment of the present application mainly includes a first receiving module 91, a determination module 92 and a first sending module 93.

The first receiving module 91 is configured to receive multiple source group query messages respectively sent by multiple second communication nodes.

The determination module 92 is configured to determine a report message and select any second communication node based on the multiple source group query messages.

The first sending module 93 is configured to send the report message to the selected second communication node.

In an exemplary implementation, the determination module 92 is configured to select one second communication node from the multiple second communication nodes based on a preset selection algorithm in a case where a same multicast traffic corresponds to the multiple second communication nodes.

In an exemplary implementation, the preset selection algorithm includes one or more of: a selection of a second communication node with a lowest BFR-Prefix value, a selection of a second communication node with a highest BFR-Prefix value, a selection of a second communication node with a lowest BFR-ID value, a selection of a second communication node with a highest BFR-ID value, or a highest random weight (HRW) algorithm.

In an exemplary implementation, the determination module 92 is configured to select one second communication node from the multiple second communication nodes based on the HRW algorithm. In an exemplary implementation, the determination module 92 is configured to: determine a weight value of each second communication node, and determine a second communication node corresponding to a maximum weight value as the selected second communication node.

In an exemplary implementation, the weight value of the second communication node is determined by group information and source information which are carried in a respective one of the multiple source group query messages corresponding to this second communication node.

In an exemplary implementation, the determination module 92 is configured to: compare flow information in the multiple source group query messages with flow information needed to be received locally, and write flow information which does not need to be received locally in the flow information in the multiple source group query messages into filtering information, where the filtering information is carried in the report message.

In an exemplary implementation, the filtering information is carried in a form of a type-length-value (TLV).

The message processing apparatus provided in this embodiment may perform the message processing method provided in any of the embodiments of the present application, and has a corresponding function module and beneficial effects for performing the method. Technical details not described in this embodiment may refer to the message processing method provided in any of the embodiments of the present application.

In the above-described embodiments of the message processing apparatus, each unit and module included in the message processing apparatus are only divided according to functional logic, but are not limited to the above-described divisions, so long as corresponding functions may be realized, in addition, the names of the function units are also only to facilitate distinguishing from each other and are not intended to limit the scope of protection of the present application.

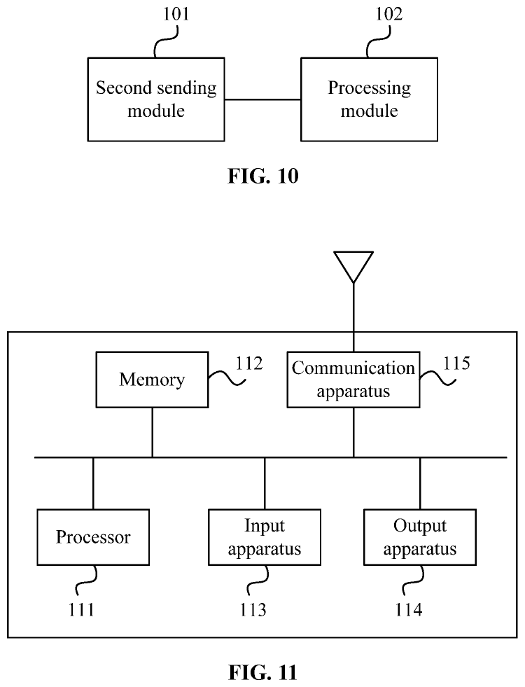

In an exemplary implementation, this embodiment provides a message processing apparatus, FIG. 10 is a schematic structural diagram of a message processing apparatus provided in the present application. The apparatus may be suitable for a condition of multicast information interaction in a large network or a slightly complex deployment scenario. The apparatus is configured at a second communication node, and the message processing apparatus may be implemented by software and/or hardware.

As shown in FIG. 10, the message processing apparatus provided in the embodiment of the present application mainly includes a second sending module 101 and a processing module 102.

The second sending module 101 is configured to send a source group query message to a first communication node, where the source group query message is used by the first communication node to determine any second communication node and a report message. The processing module 102 is configured to process multicast traffic based on the received report message.

In an exemplary implementation, the source group query message carries group information and source information, and the group information and the source information are used for the first communications node to determine a weight value of the second communication node.

In an exemplary implementation, that the multicast traffic is processed based on the received report message includes: the multicast traffic is sent to the first communication node corresponding to the report information.

In an exemplary implementation, the processing module 102 is configured to: filter the multicast traffic corresponding to the filtering information in a case where filtering information is carried in the report message, and send the filtered multicast traffic to the first communication node corresponding to the report information.

In an exemplary implementation, the processing module 102 is configured to: determine a correspondence between the multicast traffic and the first communication node based on the report information, and encapsulate the correspondence in a bit indexed explicit replication (BIER) header.

The message processing apparatus provided in this embodiment may perform the message processing method provided in any of the embodiments of the present application, and has a corresponding function module and beneficial effects for performing the method. Technical details not described in this embodiment may refer to the message processing method provided in any of the embodiments of the present application.

In the above-described embodiments of the message processing apparatus, each unit and module included in the message processing apparatus are only divided according to functional logic, but are not limited to the above-described divisions, so long as corresponding functions may be realized, in addition, the names of the function units are also only to facilitate distinguishing from each other and are not intended to limit the scope of protection of the present application.

An embodiment of the present application further provides a device. FIG. 11 is a schematic structural diagram of a device provided in an embodiment of the present application, as shown in FIG. 11, the device includes a processor 111, a memory 112, an input apparatus 113, an output apparatus 114 and a communication apparatus 115. A number of processors 111 in the device may be one or more, one processor 111 is used as an example in FIG. 11; the processor 111, the memory 112, the input apparatus 113 and the output apparatus 114 in the device may be connected by a bus or in other manners, for example, they are connected by the bus in FIG. 11.

The memory 112 serves as a computer-readable storage medium and may be used for storing a software program, a computer executable program and a module, such as a program instruction/module corresponding to the message processing method in the embodiments of the present application (such as, the first receiving module 91, the determination module 92 and the first sending module 93 in the message processing apparatus), or a program instruction/module corresponding to the message processing method in the embodiments of the present application (such as, the second sending module 101 and the processing module 102 in the message processing apparatus). The processor 111 executes various function applications and data processing of the device, i.e., implements any one of the message processing methods provided in the embodiments of the present application, by executing software programs, instructions, and modules stored in the memory 112.

The memory 112 mainly includes a storage program region and a storage data region, where the storage program region may store an operating system, an application program required for at least one function; the storage data region may store data or the like created according to the use of the device. Moreover, the memory 112 may include a high-speed random access memory and may also include a non-volatile memory, such as at least one magnetic disk storage device, flash memory device, or other non-volatile solid-state memory devices. In some instances, the memory 112 may include a memory remotely disposed with respect to the processor 111, these remote memories may be connected to the device over a network. Instances of above-described networks include, but are not limited to, an Internet, an intranet, a local area network, a mobile communication network, and combinations thereof.

The input apparatus 113 may be configured to receive entered numeric or character information and generate key signal inputs related to user settings and function controls of the device. The output apparatus 114 may include a display device such as a display screen.

The communication apparatus 115 may include a receiver and a transmitter. The communication apparatus 115 is configured to perform an information transceiving communication according to the control of the processor 111.

In a case where the above-described device is a first communication node, the processor 111 executes various function applications and data processing by running programs stored in the system memory 112, for example, implements the message processing method provided in the embodiments of the present application, and the method includes: multiple source group query messages respectively sent by multiple second communication nodes are received; a report message is determined based on the multiple source group query messages and any second communication node of the multiple second communication nodes is selected based on the multiple source group query messages; and the report message is sent to the selected second communication node.

The processor 111 may also implement the technical schemes of the message processing method provided in any of the embodiments of the present application. The hardware structure and the function of the device may be explained with reference to the contents of this embodiment.

In a case where the above-described device is a second communication node, the processor 111 executes various function applications and data processing by running programs stored in the system memory 112, for example, implements the message processing method provided in the embodiments of the present application, the method includes: a source group query message is sent to a first communication node, where the source group query message is used by the first communication node to determine any second communication node and a report message; and multicast traffic is processed based on the received report message.

The processor 111 may also implement the technical schemes of the message processing method provided in any of the embodiments of the present application. The hardware structure and the function of the device may be explained with reference to the contents of this embodiment.

In an exemplary implementation, an embodiment of the present application further provides a message processing system. The system includes a first communication node and a second communication node. The second communication node is configured to send a source group query message to a first communication node. The first communication node is configured to: receive multiple source group query messages respectively sent by multiple second communication nodes, determine a report message and any second communication node based on the multiple source group query messages, and send the report message to the selected second communication node. The second communication node is configured to process multicast traffic based on the received report message.

The message processing apparatus provided in this embodiment may perform the message processing method provided in any of the embodiments of the present application, and has a corresponding function module and beneficial effects for performing the method. Technical details not described in this embodiment may refer to the message processing method provided in any of the embodiments of the present application.

In an exemplary implementation, an embodiment of the present application further provides a storage medium including a computer-executable instruction. The computer-executable instruction is configured to perform, when executed by a computer processor, the message processing method, and the method includes: multiple source group query messages respectively sent by multiple second communication nodes are received; a report message is determined based on the multiple source group query messages and any second communication node of the multiple second communication nodes is selected based on the multiple source group query messages; and the report message is sent to the selected second communication node.

According to the storage medium including the computer-executable instruction provided in the embodiments of the present application, the computer-executable instruction is configured to implement operations not limited to the message processing method described above, but also configured to implement relevant operations in the message processing method provided in any of the embodiments of the present application.

An embodiment of the present application further provides a non-transitory computer-readable storage medium including a computer-executable instruction. The computer-executable instruction is configured to perform, when executed by a computer processor, the message processing method, and the method includes: a source group query message is sent to a first communication node, where the source group query message is used by the first communication node to determine any second communication node and a report message; and multicast traffic is processed based on the received report message.

According to the storage medium including the computer-executable instruction provided in the embodiments of the present application, the computer-executable instruction is configured to perform operations not limited to the message processing method described above, but also configured to implement relevant operations in the message processing method provided in any of the embodiments of the present application.

From the above description of the implementations, the present application may be implemented by means of software and necessary general purpose hardware, and may also be implemented by hardware. The technical scheme of the present application may be embodied in the form of a software product, and the computer software product may be stored in a computer readable storage medium, such as a floppy disk of a computer, a read-only memory (ROM), a random access memory (RAM), a flash memory (FLASH), a hard disk or an optional disk, including multiple instructions to enable a computer device (which may be a personal computer, a server, or a network device, etc.) to perform the method of the embodiments of the present application.

The term “user equipment” covers any suitable type of wireless user equipment such as a mobile phone, a portable data processing apparatus, a portable web browser or a vehicle-mounted mobile station.

In general, various embodiments of the present application may be implemented in hardware or special purpose circuits, software, logic or any combination thereof. For example, some aspects may be implemented in hardware, while other aspects may be implemented in firmware or software which may be executed by a controller, a microprocessor or other computing devices, although the present application is not limited thereto.

Embodiments of the present application may be implemented by a data processor of a mobile device executing computer program instructions, for example in a processor entity, or by hardware, or by a combination of software and hardware. The computer program instructions may be assembler instructions, instruction set architecture (ISA) instructions, machine instructions, machine-related instructions, microcode, firmware instructions, state setting data, or source or object codes written in any combination of one or more programming languages.

Any block diagram of the logic flow in the accompanying drawings of the present application may represent program processes, or may represent interconnected logic circuits, modules, and functions, or may represent a combination of program processes and logic circuits, modules, and functions. The computer program may be stored on a memory. The memory may be of any type suitable for the local technical environment and may be implemented using any suitable data storage technology, such as, but not limited to, a read-only memory (ROM), a random access memory (RAM), an optical memory device and system (digital versatile disc (DVD) or compact disk (CD)), etc. Computer readable media may include non-instantaneous storage media. Data processors may be of any type suitable for the local technical environment, such as, but not limited to, general-purpose computers, specialized computers, microprocessors, digital signal processors (DSP), application specific integrated circuits (ASIC), field programmable gate array (FPGA)), and processors based on multi-core processor architectures.

1. A message processing method, applied to a first communication node, comprising;
receiving a plurality of source group query messages respectively sent by a plurality of second communication nodes;
determining a report message based on the plurality of source group query messages and selecting one second communication node based on the plurality of source group query messages as a selected second communication node; and
sending the report message to the selected second communication node.

2. The method of claim 1, wherein selecting the one second communication node based on the plurality of source group query messages comprises:
in a case where a same multicast traffic corresponds to the plurality of second communication nodes, selecting the one second communication node from the plurality of second communication nodes based on a preset selection algorithm.

3. The method of claim 2, wherein the preset selection algorithm comprises at least one of:
selecting a second communication node with a lowest bit-forwarding router-prefix (BFR-Prefix) value from the plurality of second communication nodes;
selecting a second communication node with a highest BFR-Prefix value from the plurality of second communication nodes;
selecting a second communication node with a lowest bit-forwarding router-identifier (BFR-ID) value from the plurality of second communication nodes;
selecting a second communication node with a highest BFR-ID value from the plurality of second communication nodes; or
a highest random weight (HRW) algorithm.

4. The method of claim 3, wherein selecting the one second communication node from the plurality of second communication nodes based on the HRW algorithm comprises:
determining a weight value of each second communication node of the plurality of second communication nodes; and
determining a second communication node corresponding to a maximum weight value among a plurality of determined weight values as the selected second communication node.

5. The method of claim 4, wherein the weight value of each second communication node is determined by group information and source information which are carried in a respective one of the plurality of source group query messages corresponding to each second communication node.

6. The method of claim 1, wherein determining the report message based on the plurality of source group query messages comprises:
comparing flow information in the plurality of source group query messages with flow information needed to be received locally; and
writing flow information which does not need to be received locally in the flow information in the plurality of source group query messages into filtering information; wherein the filtering information is carried in the report message.

7. The method of claim 6, wherein the filtering information is carried in a form of a type-length-value (TLV).

8. A message processing method, applied to a second communication node, comprising:
sending a source group query message to a first communication node, wherein the source group query message is used by the first communication node to determine one second communication node and a report message; and
processing multicast traffic based on a received report message.

9. The method of claim 8, wherein the source group query message carries group information and source information, and the group information and the source information are used by the first communications node to determine a weight value of the second communication node sending the source group query message.

10. The method of claim 9, wherein processing the multicast traffic based on the received report message comprises:
sending the multicast traffic to the first communication node corresponding to the report information.

11. The method of claim 10, wherein sending the multicast traffic to the first communication node corresponding to the report information comprises:
in a case where filtering information is carried in the report message, filtering multicast traffic corresponding to the filtering information; and
sending a filtered multicast traffic to the first communication node corresponding to the report information.

12. The method of claim 9, wherein processing the multicast traffic based on the received report message comprises:
determining a correspondence between the multicast traffic and the first communication node based on the report information; and
encapsulating the correspondence in a bit indexed explicit replication (BIER) header.

13. (canceled)

14. (canceled)

15. A device, comprising:
at least one processor;
a memory, which is configured to store at least one program;
wherein the at least one program, when executed by the at least one processor, causes the at least one processor to implement:
receiving a plurality of source group query messages respectively sent by a plurality of second communication nodes;
determining a report message based on the plurality of source group query messages and selecting one second communication node based on the plurality of source group query messages as a selected second communication node; and
sending the report message to the selected second communication node.

16. A non-transitory computer-readable storage medium, storing a computer program, wherein the computer program, when executed by a processor, implements the message processing method of claim 1.

17. A message processing system, comprising a first communication node and a second communication node, wherein,
the second communication node is configured to send a source group query message to a first communication node;
the first communication node is configured to: receive a plurality of source group query messages respectively sent by a plurality of second communication nodes; determine a report message based on the plurality of source group query messages and select a second communication node of the plurality of second communication nodes based on the plurality of source group query messages; and send the report message to the selected second communication node; and
the second communication node is further configured to process multicast traffic based on the received report message.

18. A device, comprising:
at least one processor;
a memory, which is configured to store at least one program;
wherein the at least one program, when executed by the at least one processor, causes the at least one processor to implement the message processing method of claim 8.

19. A non-transitory computer-readable storage medium, storing a computer program, wherein the computer program, when executed by a processor, implements the message processing method of claim 8.
